(19) United States
(12) Patent Application Publication
(10) Pub. No.: US 2005/0139280 A1
(43) Pub. Date: Jun. 30, 2005

(54) Composite pressure pipe

(76) Inventors: Hiroyuki Masui, Osaka (JP); Tatsuya Machino, Osaka (JP); Yasushi Sakane, Osaka (JP); Shoji Hirao, Osaka (JP); Yoshiaki Hayashi, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 11/012,101

(22) Filed: Dec. 16, 2004

(30) Foreign Application Priority Data
Dec. 19, 2003 (JP) 2003-423403

(51) Int. Cl. F16L 9/14

(52) U.S. Cl. 138/121; 138/146; 138/143

(57) ABSTRACT

A composite pressure pipe which comprises an inner layer (1) made of a synthetic resin, a reinforcing band (2) which is made of a metal and is spirally wound around the outer circumferential surface of the inner layer (1), and an outer layer (3) which is made of a synthetic resin and with which the outer circumferential surface of the reinforcing band is covered. The outer layer (3) has a filling part (21) united therewith which fills the recess (20) formed between each pair of ridge parts (11) and (11) of the reinforcing band (2) which are adjacent to each other in the pipe axis direction.

### BACKGROUND OF THE INVENTION

1. Field of the Invention

The present invention relates to a composite pressure pipe suitable for use as a drainage pipe, a cable protection pipe, or the like which are to be mainly laid in the ground.

2. Description of Related Art

Composite pressure pipes comprising a corrugated pipe main body made of a synthetic resin and a reinforcing metallic band embedded in the main body so as to enhance pressure resistance have been known as drainage pipes or cable protection pipes to be laid in the ground.

This kind of composite pipes include one in which a reinforcing band having a continuous ridge extending in the lengthwise direction and projecting in radial directions has been spirally wound so that edges of the band which are opposed to each other in the pipe axis direction are spaced so as to form a gap therebetween, as disclosed in JP-UM-A-61-141889 (Japanese Utility Model Laid-open Number 1986-141889). In this composite pipe, the gap is a part which consists of a synthetic resin only and in which the reinforcing band is not present. This composite pipe thus retains satisfactory flexibility.

However, this composite pipe, in which a reinforcing band has been spirally wound so as to form a gap between adjacent parts thereof in the pipe axis direction, has had the following problem. When an excessive external pressure, e.g., soil pressure, is applied to the pipe and the reinforcing band is thus pressed toward the center of the pipe, then both edges of the reinforcing band which extend along the lengthwise direction expand relatively easily in the pipe axis direction. Namely, the reinforcing band readily deforms. As a result, the wall of the composite pipe creases or cracks with the deformation. Consequently, there has been room for improvement from the standpoint of imparting higher pressure resistance to pipes to be laid deeply in the ground or to pipes for underground laying which are to be used under such conditions that the soil contains impurities or has uneven particle diameters and, hence, it is difficult to disperse the soil pressure evenly to the whole pipe, as in the case where a low-reaction-force soil such as, e.g., the soil resulting from ground cutting for forming a ditch for pipe laying is used for back filling after pipe laying.

Because of this, there is a composite pipe including another metallic band which has been embedded in the corrugated pipe main body so as to inhibit the expansion of both edges of the reinforcing band which extend along the lengthwise direction, as disclosed in, e.g., JP-A-6-174154 (Japanese Patent Laid-open Number 1994-174154). This composite pipe thus has a constitution which inhibits reinforcing band deformation, heightens the strength against flattening by pressure, and enables the pipe to withstand higher external pressures.

However, the composite pipe disclosed in JP-A-6-174154 has a drawback that it is necessary to newly use a metallic band besides the reinforcing band in order to inhibit deformation of the reinforcing band, resulting in an increase in the number of parts. In addition, production of this composite pipe necessitates an operation in which the metallic band is bent along the edges thereof to engage it with both edges of the reinforcing band or an operation in which the edges of the metallic band are bonded to the edges of the reinforcing band by melting a resin coating film with which these bands are coated. Because of this, the composite pipe has had a drawback that the pipe production steps are complicated.

### SUMMARY OF THE INVENTION

An object of the invention is to provide a composite pressure pipe of which in spite of a simple structure, deformation is effectively inhibited under external pressures so as to exhibit high pressure resistance.

In order to accomplish the object, the invention provides a composite pressure pipe having a pipe wall which comprises an inner layer made of a synthetic resin, a reinforcing band which is made of a metal and is circularly or spirally wound around the outer circumferential surface of the inner layer, and an outer layer which is made of a synthetic resin and with which the outer circumferential surface of the reinforcing band is covered. The reinforcing band has a continuous ridge which extends in the band lengthwise direction and projects in pipe radial directions. The outer layer has a filling part which fills the recess formed between each pair of parts of the ridge which are adjacent to each other in the pipe axis direction, at least a half of the depth of the recess being thus filled.

In the composite pressure pipe of the invention, even when a high external pressure such as, e.g., soil pressure is applied thereto, the filling part of the outer layer inhibits the edges of the reinforcing band which extend along the band lengthwise direction from expanding in the pipe axis direction, whereby the reinforcing band can be inhibited from deforming. Because of this, the reinforcing band in this composite pressure pipe sufficiently withstands external pressures to thereby attain improved pressure resistance. As a result, the pipe wall is less apt to suffer a conspicuous abnormality in appearance, such as creasing or cracking, and can enhance safety and reliability.

In addition, since pressure resistance is heightened by using the outer layer to fill the recess between ridge parts of the reinforcing band, simplification in the structure of the composite pressure pipe and simplification of production steps can be attained as compared with the case where another metallic band is newly used as in the related-art technique described above.

### BRIEF DESCRIPTION OF THE DRAWINGS

FIG. 1 is a partially cutaway slant view of a composite pressure pipe according to one embodiment of the invention.

FIG. 2 is a vertical sectional view of a pipe wall part of the composite pressure pipe.

FIG. 3 is a vertical sectional view of a pipe wall part of a composite pressure pipe according to another embodiment of the invention.

### DETAILED DESCRIPTION OF THE INVENTION

Embodiments of the invention will be explained below in detail by reference to the drawings. The composite pressure pipe according to one embodiment of the invention is one for use as, e.g., a drainage pipe to be laid in the ground.

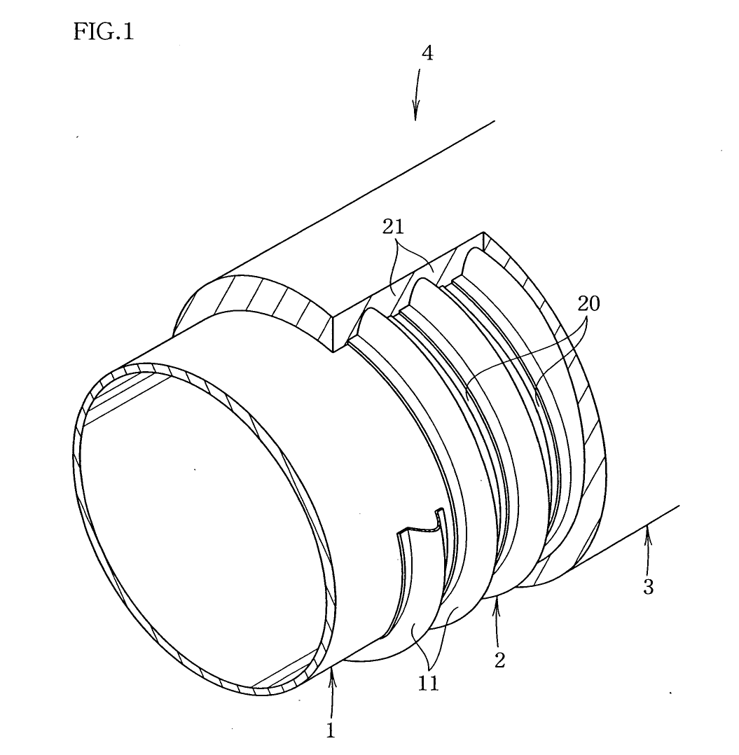

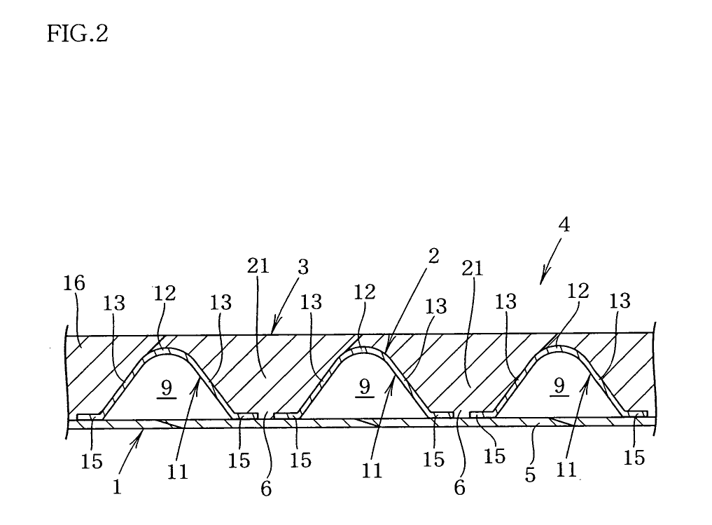

As shown in FIGS. 1 and 2, this composite pressure pipe has a pipe wall (4) which comprises the following layers superposed in this order from inside: an inner layer (1) made of a synthetic resin; a reinforcing band (2) which is made of a metal and has been disposed along the outer circumferential surface of the inner layer (1); and an outer layer (3) which is made of a synthetic resin and with which the outer circumferential surface of the reinforcing band (2) is covered.

The inner layer (1) has been formed by spirally winding a strip (5) made of a synthetic resin, e.g., a polyethylene resin, and thermally fusion-bonding the edges thereof which are adjacent to each other in the pipe axis direction. In place of the thermal fusion, bonding may be used to bond the edges to each other. This inner layer (1) has been formed in a cylindrical shape which has almost even thickness throughout the whole length in the pipe axis direction and the inner and outer circumferential surfaces of which are almost smooth.

The reinforcing band (2) consists of, e.g., a strip-form steel sheet the surfaces of which have been wholly coated with a synthetic resin film. It has been spirally wound around the outer circumferential surface of the inner layer (1) so as to form a gap (6) between adjacent parts thereof in the pipe axis direction.

This reinforcing band (2) has a continuous ridge (11) which has a hill-shaped section and which extends in the band lengthwise direction and projects in pipe radial directions so as to form a space (9) between the reinforcing band (2) and the outer circumferential surface of the inner layer (1). The ridge (11) comprises a top part (12) having an arc-shaped section and a pair of side wall parts (13) and (13) obliquely extending from the top part (12) toward the inner layer (1) so as to expand.

Furthermore, the reinforcing band (2) has flanges (15) and (15) at the edges on the respective sides along the band lengthwise direction. The flanges (15) and (15) have been formed by bending edge parts of the side wall parts (13) and (13), and project in the pipe axis direction so that the opposed parts thereof are apart from each other.

The outer layer (3) has been formed by spirally winding a strip (16) made of a synthetic resin, e.g., a polyethylene resin, and thermally fusion-bonding the edges thereof which are adjacent to each other in the pipe axis direction. In place of the thermal fusion, bonding may be used to bond the edges to each other.

This outer layer (3) has a spirally corrugated inner circumferential surface corresponding to the outer circumferential surface of the reinforcing band (2), and has an almost smooth outer circumferential surface. Namely, the outer layer (3) has a filling part (21) united therewith which wholly fills the recess (20) formed between ridge parts (11) and (11) of the reinforcing band (2) which are adjacent to each other in the pipe axis direction. This filling part (21) has been spirally formed on the inner circumferential side of the outer layer (3) so as to have a nearly trapezoidal section conforming to the shape of the recess (20).

This filling part (21), which is part of the outer layer (3), inhibits the side wall parts (13) and (13) of the ridge (11) of the reinforcing band (2) from expanding in the pipe axis direction. The filling part (21) thus functions to inhibit the reinforcing band (2) from deforming under external pressure.

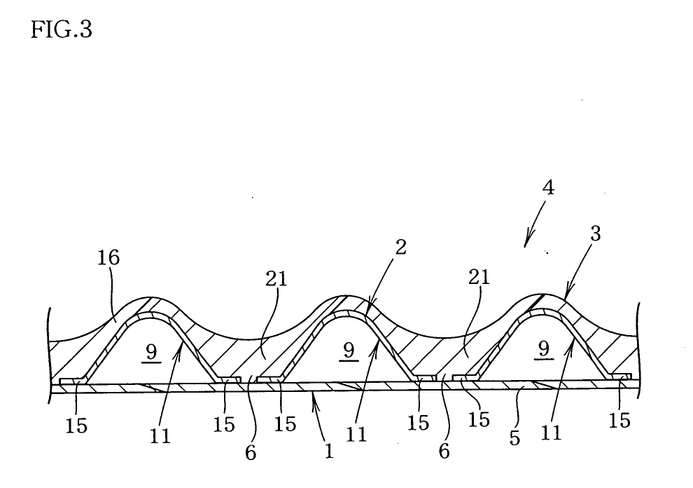

Incidentally, the filling part (21) need not wholly fill the recess (20) as in the embodiment described above, because to fill at least a half of the depth of the recess (20) is sufficiently effective in inhibiting the side wall parts (13) and (13) of the ridge (11) from expanding in the pipe axis direction. For example, the filling part (21) may be formed so that the recess (20) is filled therewith to a depth slightly larger than a half of the depth of the recess (20), as shown in FIG. 3. In this case, the outer circumferential surface of the outer layer (3) has a spirally corrugated shape.

A composite pipe having the constitution described above is produced in the following manner. A synthetic-resin strip (5) extruded from an extruder is spirally wound on a mandrel, and the edges thereof which are adjacent to each other in the mandrel axis direction are thermally fused to each other. Thus, a cylindrical inner layer (1) is formed.

Subsequently, a reinforcing band (2) having a ridge (11) is spirally wound around the outer circumferential surface of the inner layer (1) in such a manner as to form a gap (6) between adjacent parts thereof in the pipe axis direction, i.e., in such a manner that a flange (15) and a flange (15) which are opposed to each other in the pipe axis direction are not in contact with each other and are apart from each other at a given distance. Thereafter, the synthetic-resin coating film formed on the inner circumferential surface of the flanges (15) and (15) of the reinforcing band (2) is thermally fused to the outer circumferential surface of the inner layer (1).

Finally, a synthetic-resin strip (16) which has been extruded from an extruder and has a filling part (21) is spirally wound, and the edges thereof which are adjacent to each other in the pipe axis direction are thermally fused to each other. Thus, an outer layer (3) is formed. In this operation, the filling part (21) is fitted into the recess (20) between ridge parts (11) and (11) of the reinforcing band (2). Thereafter, the synthetic-resin coating film formed on the outer circumferential surfaces of the ridge (11) and flanges (15) and (15) of the reinforcing band (2) is thermally fused to the inner circumferential surface of the outer layer (3). In addition, the gap (6) resulting from the winding of the reinforcing band (2) is used to directly bond the inner layer (1) to the outer layer (3) by thermal fusion. Thus, the inner layer (1), reinforcing band (2), and outer layer (3) are thermally fused and united with each other.

In the composite pipe described above, even when an external pressure such as soil pressure is applied thereto and the reinforcing band (2) is pressed toward the center of the pipe, the filling part (21) of the outer layer (3) inhibits the reinforcing band (2) from expanding in the pipe axis direction, whereby the reinforcing band (2) can be inhibited from deforming. Because of this, the reinforcing band (2) in this composite pressure pipe sufficiently withstands external pressures. Consequently, the composite pipe has high yield stress with no yield point in a practical range, and is far tougher than the hume pipes which break at a degree of deformation of about 5%. The composite pipe has a structure in which the pipe wall (4) is less apt to suffer a conspicuous abnormality in appearance, such as creasing or cracking.

In addition, since pressure resistance is enhanced by using the outer layer (3) to fill the recess (20) between ridge parts (11) and (11) of the reinforcing band (2), the composite pressure pipe can have a simplified structure and production steps can be simplified.

Furthermore, in this composite pressure pipe, since the recess (20) is wholly filled, deformation of the reinforcing band (2) can be inhibited without fail and high pressure resistance can be exhibited with higher certainty.

Moreover, since the outer layer (3) and the inner layer (1) is formed so as to have an almost smooth outer circumferential surface and an almost smooth inner circumferential surface, respectively, the composite pipe not only has a reduced pressure loss during fluid transportation but also has satisfactory handleability which enables the pipe to be less caught by other members when laid.

The reinforcing band (2) is spirally wound so as to form a gap (6) between adjacent parts thereof in the pipe axis direction, and this gap (6) is occupied by a part consisting only of a synthetic resin material which directly bond the inner layer (1) to the outer layer (3) through thermal fusion. Consequently, not only the inner layer (1) or outer layer (3) can be prevented, without fail, from peeling off, but also the composite pipe can retain satisfactory flexibility.

Furthermore, since the reinforcing band (2) has flanges (15) and (15), the reinforcing band (2) can be stably embedded in the pipe wall (4). Since the reinforcing band (2) has a synthetic-resin coating film formed on the inner and outer circumferential surfaces thereof, it can be thermally fused to the inner layer (1) and outer layer (3), which each are made of a synthetic resin. Consequently, the inner and outer layers (1) and (3) and the reinforcing band (2) can be tenaciously united to thereby further enhance pressure resistance.

Moreover, since the inner and outer layers (1) and (3) are formed by spirally winding synthetic-resin strips (5) and (16) and the reinforcing band (2) is spirally wound, a composite pressure pipe can be continuously produced in any desired length. Productivity can hence be heightened.

The invention should not be constructed as being limited to the embodiments described above, and it is a matter of course that many changes and modifications can be made in the embodiments within the scope of the invention. For example, although the inner and outer layers and the reinforcing band in the embodiments described above were thermally fused to each other, these members may be united by bonding. Although the reinforcing band was spirally wound, it is possible to circularly dispose reinforcing bands along the outer circumferential surface of the inner layer. The sectional shape of the ridge of the reinforcing band is not limited to a hill shape, and maybe, for example, rectangular, trapezoidal, or semicircular. Furthermore, the composite pipe of the invention may be used, e.g., as a cable protection pipe for underground laying, besides being used as a drainage pipe to be laid in the ground.

1. A composite pressure pipe having a pipe wall which comprises an inner layer made of a synthetic resin, a reinforcing band which is made of a metal and is circularly or spirally wound around the outer circumferential surface of the inner layer, and an outer layer which is made of a synthetic resin and with which the outer circumferential surface of the reinforcing band is covered, wherein the reinforcing band has a continuous ridge which extends in the band lengthwise direction and projects in pipe radial directions and the outer layer has a filling part which fills the recess formed between each pair of parts of the ridge which are adjacent to each other in the pipe axis direction, at least a half of the depth of the recess being thus filled.

2. The composite pressure pipe of claim 1, wherein the filling part fills the whole recess.

3. The composite pressure pipe of claim 1, wherein the filling part is part of the outer layer.

4. The composite pressure pipe of claim 1, wherein the outer layer is formed so that the outer circumferential surface thereof is almost smooth.

5. The composite pressure pipe of claim 1, wherein the inner layer is formed so that the inner circumferential surface thereof is almost smooth.

6. The composite pressure pipe of claim 1, wherein the reinforcing band is wound so as to form a gap between adjacent parts thereof in the pipe axis direction, and the inner layer and the outer layer have been thermally fused to each other or bonded to each other at the gap.

7. The composite pressure pipe of claim 1, wherein the reinforcing band has a flange at the edge on each side thereof along the band lengthwise direction, the flange projecting in the pipe axis direction so that the opposed parts of the flanges are apart from each other.

8. The composite pressure pipe of claim 1, wherein the reinforcing band has a synthetic resin coating film formed on the inner and outer circumferential surfaces thereof.

9. The composite pressure pipe of claim 1, wherein the inner and outer layers each are formed by spirally winding a synthetic-resin strip and thermally fusing or bonding the edges thereof which are adjacent to each other in the pipe axis direction, and the reinforcing band is spirally wound.

10. The composite pressure pipe of claim 1, which is for use as an underground drainage pipe.
